(19) United States
(12) Patent Application Publication
(10) Pub. No.: US 2010/0157052 A1
(43) Pub. Date: Jun. 24, 2010

(54) Close-circuit television camera having an UPS system

(76) Inventor: Hai-Chin Chang, Wugu Township (TW)

Correspondence Address: PRO-TECHTOR INTERNATIONAL SERVICES, 20775 NORADA CT., SARATOGA, CA, 95070, US

(21) Appl. No.: 12/342,630

(22) Filed: Dec. 23, 2008

(51) Int. Cl. H04N 7/18

(52) U.S. Cl. 348/143; 348/E07.085

(57) ABSTRACT

A close-circuit television camera having an UPS system comprises a housing within which are disposed a LED panel, a Lens, a camera module, an UPS module, a rechargeable battery, an UPS, a control panel or a webcam module and/or like devices. When the camera operates normally but the commercial power system is broken by external action or a sudden power failure occurs, this CCTV camera can be supplied with power by itself without the need from a commercial power source or a monitoring center, to generate images and maintain normal operation.

### BACKGROUND OF THE INVENTION

(a) Field of the Invention

The present invention relates to a close-circuit television (CCTV) camera having an UPS system, and more particularly to a camera which can be supplied with power by itself to generate images and maintain normal operation of the CCTV camera when commercial power is suddenly cut off.

(b) Description of the Prior Art

A conventional infrared CCTV camera comprises a housing within which are disposed a transparent hood, a circuit substrate, a camera base and like components. The CCTV camera is supplied with power by an external commercial power source. In the event of a commercial power failure, the camera would not operate normally.

Therefore, some skilled persons have developed a CCTV camera having an UPS. When external commercial power is suddenly cut off for a while, the standby power within the UPS can supply power directly.

The UPS is not directly arranged within the camera body and must be electrically connected to the camera by means of wiling, and it is an external device. As a result, the wiring is long and extends far to the outdoors or to distant places indoors. The camera must be supplied with power by a commercial power source or a monitoring center to maintain normal operation, and cannot be supplied with power by itself to generate images.

### SUMMARY OF THE INVENTION

A primary object of the present invention is to provide a CCTV camera having an UPS system so there is no need for additional wiring to connect with an UPS system. When the camera operates normally but the commercial power system is broken by external action or a sudden power failure occurs, this CCTV camera can be supplied with power by itself without the need from a commercial power source or a monitoring center, to generate images and maintain normal operation of the camera.

### BRIEF DESCRIPTION OF THE DRAWINGS

FIG. 1 is a schematic view of an appearance of the present invention.

FIG. 2 is a partial exploded view of the present invention.

FIG. 3 is another partial exploded view of the embodiment according to the present invention.

FIG. 4 is another schematic view of an appearance of the embodiment according to the present invention.

### DETAILED DESCRIPTION OF THE PREFERRED EMBODIMENTS

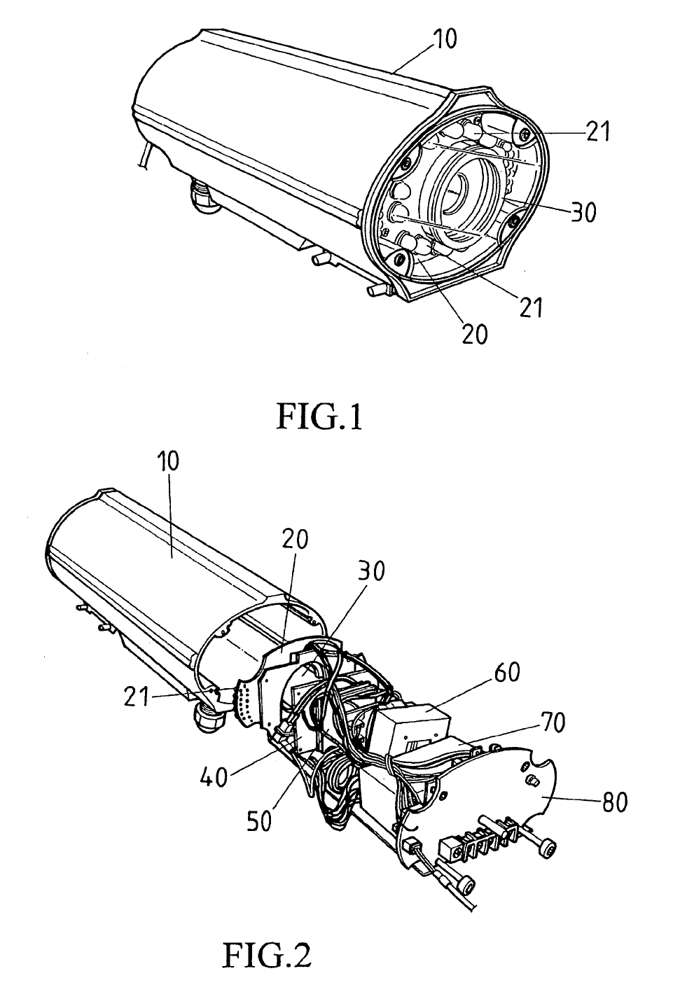

Referring to FIG. 1, the CCTV camera of the present invention comprises an Uninterruptible Power Supply (UPS) mounted within the camera. The design of the camera is dedicated to infrared CCTV cameras, webcams or network infrared cameras or the like.

Referring to FIG. 2, one aspect of the present invention is an infrared CCTV camera comprising a housing within which are disposed a LED panel 20, a lens 30, a camera module 40, an UPS module 50, a rechargeable battery 60, an UPS 70, a control panel 80 and like components. A number of infrared diodes 21 are mounted on the front edge of the LED panel 20. The lens 30 is connected at the center of the LED panel 20. The camera module 40 is connected to the rear side of the lens 30. The UPS module 50 is connected to the rear side of me camera module 40 and connected through power supply lines and signal lines to the rechargeable battery 60. The other end of the rechargeable battery 60 is connected to the UPS 70, and the UPS 70 is further connected to the control panel 80. The above infrared diodes 21 would not emit light in the daytime and can be automatically lit in the dark at night so that the CCTV camera can still perform recording and monitoring in the dark. If fire damages the power system or power is cut off, the rechargeable battery 60 itself can supply power to the infrared diodes 21 so that they are lit to maintain normal operation of the camera.

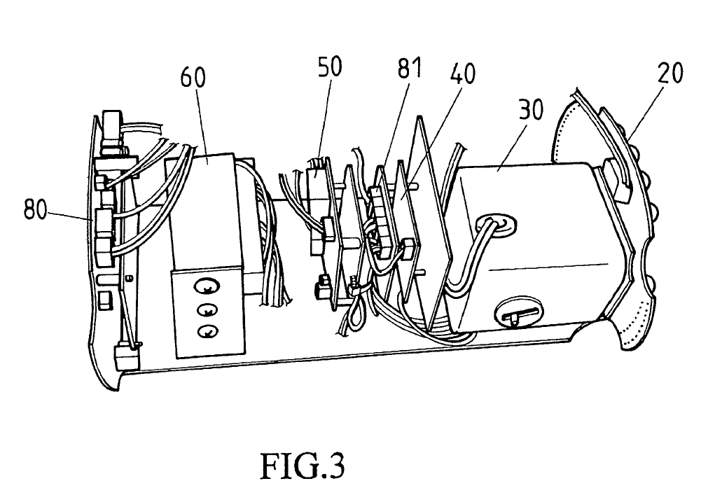

Referring to FIG. 3, when the present invention is applied to a webcam, a webcam transmission module (i.e. an IP module) 81 can be additionally mounted within the housing 10 thereof to form an IP webcam, the CCTV camera also having the functions of an UPS system.

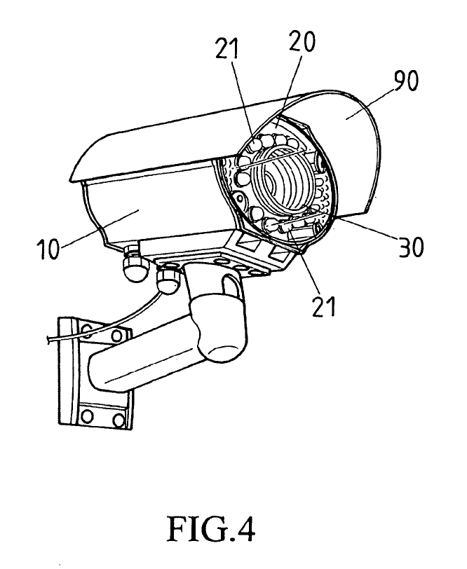

Referring to FIG. 4, when the CCTV camera of the present invention is set up on a common wall or a ceiling, an arched top cover 90 can be mounted on the housing 10 thereof.

When the present invention is developed and designed for an infrared CCTV camera or for optical fiber transmission and for a webcam, the camera is provided with a protection device. When the rechargeable battery 60 fails or abnormal charging occurs, the camera will stop charging and is provided with an indicator lamp, a buzzer or like warning devices. When the capacity of the rechargeable battery 60 is insufficient, its capacity can be expanded infinitely until the rechargeable battery 60 is full. Further, if the camera according to the present invention is in a power failure state, it is possible to selectively set whether the infrared diodes 21 are activated and lit or not. In another word, tile infrared diodes 21 are set not to emit light in the daytime so as to increase the discharge time of the camera for more hours of use. The infrared diodes 21 would be activated and lit only in the dark at night.

As apparent from the foregoing, the primary object of the present invention is to provide a close-circuit television camera having an UPS system, which relates to an infrared CCTV camera or a webcam or a network infrared camera. When commercial power is cut off, there is no need for a commercial power source or a monitoring center to supply power. The camera itself has an UPS module and can be supplied with power by itself to generate images and maintain normal operation of the camera. Therefore, this camera is very suitable for installation outdoors or in distant places indoors or in like blind spots. The camera can serve as a new IP webcam by incorporating a webcam transmission module thereinto.

1. A close-circuit television camera having an UPS system, comprising:
a housing, within which are disposed
an LED panel, on the front edge of which infrared diodes are mounted;
a lens, which is connected at the center of the LED panel;
a camera module, which is connected to the rear side of the lens;
a control panel, which is mounted on the front side of the housing;
characterized by:
an UPS module, which is connected to the rear side of the camera module;
a rechargeable battery, which is connected through power supply lines and signal lines to the UPS module; and
an UPS, which is connected to the rechargeable battery;
when the close-circuit television camera comprised of the above components operates normally but a sudden interruption of commercial power occurs, the camera can be supplied with power by itself to generate images and maintain normal operation.

2. The close-circuit television camera having an UPS system as claimed in claim 1, wherein an IP webcam comprised of a webcam transmission module is mounted within the housing, and when commercial power is cut off, the camera can be supplied with power by itself to generate images and maintain normal operation.

3. The close-circuit television camera having an UPS system as claimed in claim 1, wherein a top cover is mounted on the housing when the camera is set up.
